(19) United States
(12) Patent Application Publication
(10) Pub. No.: US 2016/0022093 A1
(43) Pub. Date: Jan. 28, 2016

(54) COOKING APPARATUS COMPRISING AT LEAST TWO REMOVEABLE PANELS

(71) Applicant: APPLICATION DE GAZ, Saint Genis Laval (FR)

(72) Inventors: Massimo GRAMOLA, Desenzano Del Garda (IT); Mirco MARAVIGLIA, Centenaro Di Lonato Del Garda (IT); Moschini MICHELE, Centenaro Di Lonato Del Garda (IT); Bruno CURSOUX, Mornant (FR); Christophe PAYSANT, Saint Etienne (FR)

(21) Appl. No.: 14/775,661

(22) PCT Filed: Oct. 22, 2013
(86) PCT No.: PCT/FR2013/052525

§ 371 Date: Sep. 11, 2015

(30) Foreign Application Priority Data
Mar. 13, 2013 (FR) 13/52232

(51) Int. Cl. A47J 37/07

(52) U.S. Cl. CPC A47J 37/07

(57) ABSTRACT

Cooking appliance comprising at least two removable panels. The invention relates to a cooking appliance (1) comprising a cooking pit defining a cooking enclosure (27) having an upper opening (5), the cooking appliance (1) also comprising a cooking grille (9) and/or plate (3) positioned facing the opening (5), and at least one burner (29) having at least one heating part arranged in the cooking enclosure (27). The cooking enclosure (27) comprises an inner side wall comprising at least two removable panels (65) for securing to a support provided in the appliance. A first removable panel (65) and an adjacent second removable panel (65) comprise a covering area (89, 91).

### TECHNICAL FIELD

The present invention relates to a cooking apparatus comprising a grill and/or cooking plate under which a cooking well extends comprising at least two removable panels.

### BACKGROUND

It is known to have a cooking apparatus having a cooking well above which is disposed a grill and/or cooking plate for a foodstuff.

The heat required for cooking is generated inside the cooking well by a heat source such as a burner. The heat is directed towards the top of the cooking well and heats the food disposed on the grill and/or the cooking plate.

It is known to use such a cooking apparatus for cooking food producing a greasy liquid residue while cooking meat. The liquid residue flows inside the cooking well through the cooking grill or through openings provided for this purpose in the cooking plate.

According to the state of the technique, the cooking well has an inner enclosure provided with means for guiding liquid residue towards a collecting area inside the well. As for the collecting area, it is provided with emptying means for discharging the residue from the well.

These guiding means are satisfying in that the liquid residue from the food do not enter inside the cooking apparatus and may be discharged from the well after cooking.

However, part of the liquid residue sticks to the enclosure along the guiding means, thereby creating dirt when the liquid residue dries. One should proceed with a cleaning of the guiding means of the enclosure. This cleaning may prove to be problematic as the guiding means are not necessarily easily accessible. The enclosure may also be dismantled. In this case the dismantling and handling of the elements constituting the enclosure may prove to be fastidious.

### BRIEF SUMMARY

The present invention aims to resolve all or part of the aforementioned drawbacks.

To this end, the present invention relates to a cooking apparatus comprising a cooking well defining a cooking enclosure having an upper opening, a grill and/or cooking plate positioned facing the opening, at least a burner having at least a heating part disposed in the cooking enclosure.

The cooking enclosure comprises an inner lateral wall including at least two removable panels intended to be secured to a support comprised within the apparatus in which a first removable panel and a second adjacent removable panel having an overlapping area.

According to an aspect of the invention, the first removable panel comprises an edge superimposed to an edge of the second panel in the overlapping area.

According to an aspect of the invention, the first and second edges extend in a substantially parallel manner in the overlapping area.

According to an aspect of the invention, the overlapping area extends along a sloping line common to the first and second removable panels.

According to an aspect of the invention, the common sloping line is continuous.

According to a first variant, the common sloping line is comprised in a plane transversal to the first removable panel and second removable panel, this plane able to be vertical or oblique with respect to the vertical.

According to a second variant, the common sloping line may extend outside the transversal plane, for example by having a curved profile or a profile comprising several segments.

According to an aspect of the invention, each panel extends facing the cooking enclosure and has a slope oriented towards the inside of the cooking well.

According to an aspect of the invention, the first removable panel is form-fitted with the second removable panel on the first overlapping area.

According to an aspect of the invention, the first panel has a border in the overlapping area, the border being a profile along the common sloping line, the profile having a convex shape with respect to the inside of the cooking well and a concave shape with respect to the outside of the cooking well.

According to an aspect of the invention, the cooking enclosure comprises a third removable panel transversal to the first removable panel, the first and third panels having an overlapping area extending transversally to the slope of the first panel facing a flap arranged on the first or on the third panel.

According to an aspect of the invention, at least a panel has a notch arranging a space of the enclosure for placing a burner.

According to an aspect of the invention, the notch is located at the base of the panel slope having the notch.

According to an aspect of the invention, an inner portion achieving a horizontal contour of the cooking well is constituted by a plurality of panels, each panel having with the adjacent panel an overlapping area.

According to an aspect of the invention, the support of the cooking enclosure comprises a frame surrounding the upper opening, the removable panels comprising means for removeably securing to the frame.

According to an aspect of the invention, the support comprises a set of profiles extending from the frame around the cooking well, openings of the support being arranged between the profiles.

According to an aspect of the invention, the cooking enclosure comprises at least a removable tank constituting an area for collecting residue from the cooking.

According to an aspect of the invention, the panels form means for protecting the inside the apparatus and for guiding the cooking residue towards the tank.

According to an aspect of the invention, the tank comprises a removable plate delimiting a lower part of the cooking well.

Preferably, the plate has a peripheral rim extending towards the top of the cooking well.

According to an aspect of the invention, the tank extends along at least a horizontal direction towards the outside of the well beyond the base of the slope of the adjoining panel.

According to an aspect of the invention, the tank is arranged at a distance from the panels.

### BRIEF DESCRIPTION OF THE DRAWINGS

Anyway, the invention will be better understood by means of the following description in reference to the accompanying schematic drawing representing, by way of non-limiting example, an embodiment of this cooking apparatus.

FIG. 1 is a perspective view of an upper part of a cooking apparatus comprising a cooking plate.

FIG. 2 is a perspective view of the upper part of the cooking apparatus without the cooking plate.

FIG. 3 is a perspective view of a cooking well of the cooking apparatus.

FIG. 4 is a detailed view of an overlapping area of two removable panels.

FIG. 5 is another detailed view of an overlapping area of two removable panels.

FIGS. 6 to 8 are exploded views of the cooking well of the cooking apparatus.

FIG. 9 is a side view of the cooking well.

FIG. 10 is a detail of a side view of the cooking well.

### DETAILED DESCRIPTION

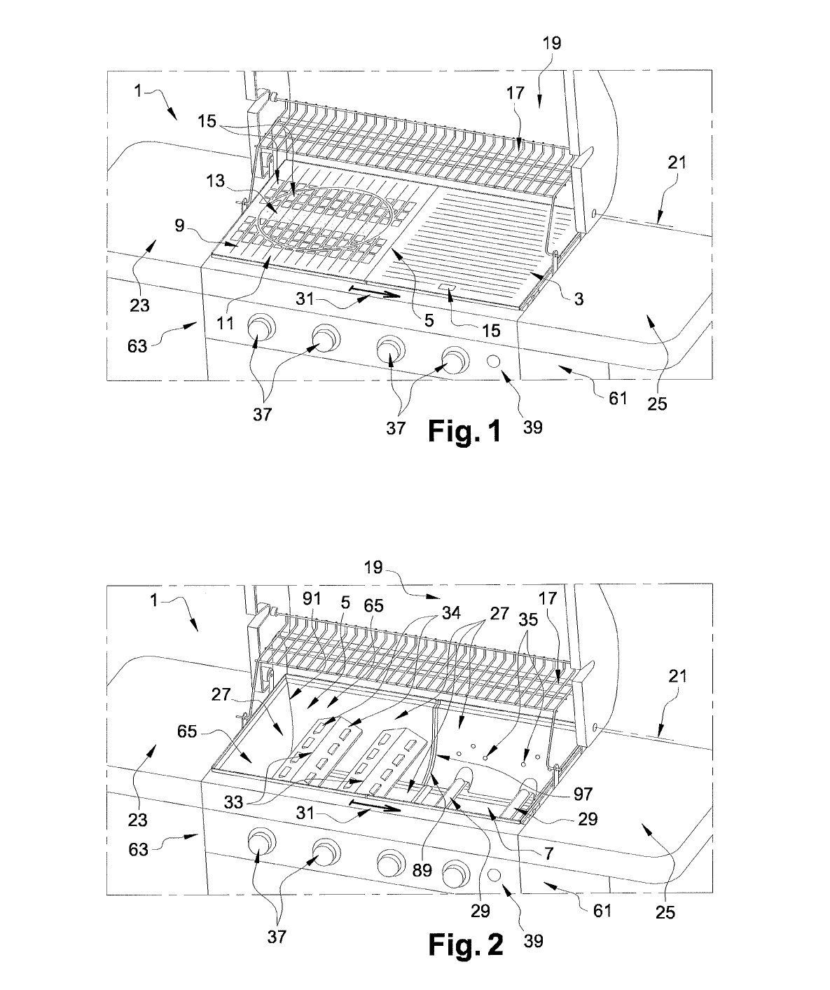

As illustrated on FIG. 1, a cooking apparatus 1 comprises a cooking plate 3 substantially horizontal disposed facing a first portion of an opening 5 of a cooking well 7. The cooking plate 3 is rectangular and substantially planar.

The cooking apparatus 1 comprises a cooking grill 9 adjoining the cooking plate 3 and disposed facing a second portion of the opening 5 of the cooking well 7. The cooking grill 9 is also substantially planar.

The set constituted of the cooking plate 3 and the cooking grill 9 corresponds to the opening 5.

The cooking grill 9 comprises a first rectangular element 11 provided with a circular opening and a second circular element 13 disposed in the circular opening. The cooking plate 3 and the cooking grill 9 are provided with openings 15 in fluidic communication with the cooking well 7 and the outside.

The cooking apparatus 1 comprises an upper grill 17 arranged facing and at a distance from the opening 5 of the cooking well 7. The cooking apparatus 1 also comprises a cap 19 pivoting around an axis of rotation 21. On FIG. 1, the pivoting cap 19 is in lifted position and supports the upper grill 17. In lowered position, the pivoting cap 19 is located facing the opening 5 of the cooking well 7 and covers the cooking plate 3 and the cooking grill 9.

The cooking apparatus 1 comprises a first lateral left working plane 23 and a second lateral right working plane 25, the lateral left working plane 23 adjoining the cooking grill 9 and the lateral right working plane 25 adjoining the cooking plate 3.

The lateral right working plane 25, the lateral left working plane 23, the cooking grill 9 and the cooking plate 3 are located in a same horizontal plane.

As illustrated on FIG. 2, the opening 5 of the cooking well 7 corresponds to the place of the set constituted of the cooking plate 3 and the cooking grill 9. The inside of the cooking well 7 is delimited by a cooking enclosure 27.

Four gas burners 29 are disposed inside the cooking well 7. The burners 29 extend along a direction transversal to the main direction 31 of the opening 5 of the cooking well 7 with respect to the horizontal. The burners 29 are regularly distributed inside the cooking well 7.

A transversal wall 33 for diffusing heat is disposed vertically to each burner 29 between the burner 29 and the opening 5 of the cooking well 7.

On FIG. 2, only the transversal diffusing walls 33 of the two left burners 29 are represented. Each transversal wall has two slopes 34 in the direction of the lower part of the cooking well 7. The transversal diffusing walls 33 of the two right burners 29 are not represented in order to keep the burners 29 and fixing points 35 of the transversal walls 33 visible on the cooking enclosure 27.

Four regulating buttons 37 are disposed on the external wall of the cooking apparatus 1 in the extension of the burners 29 of the opposite side to the pivoting cap 19 with respect to the opening 5 of the cooking well 7. The adjusting buttons 37 are arranged for regulating the gas supply to the burners 29.

A red light 39 is disposed on the outer wall of the cooking apparatus 1 in the alignment of the adjusting buttons 37 on the right side. The red light 39 is arranged to come on when at least one burner 29 is supplied with gas.

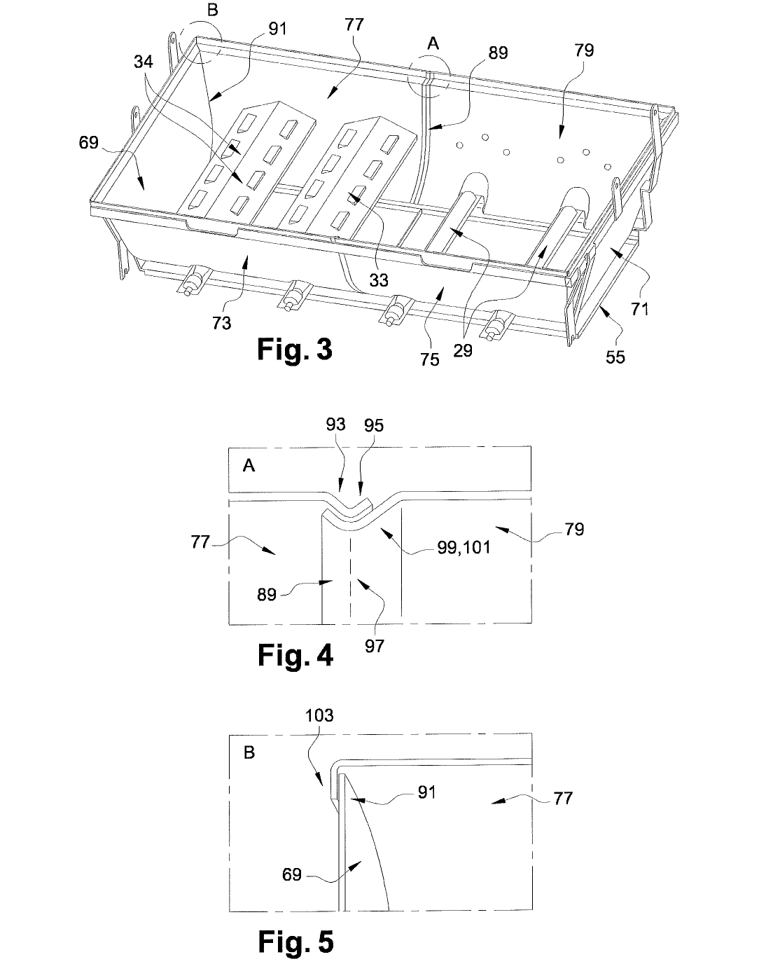

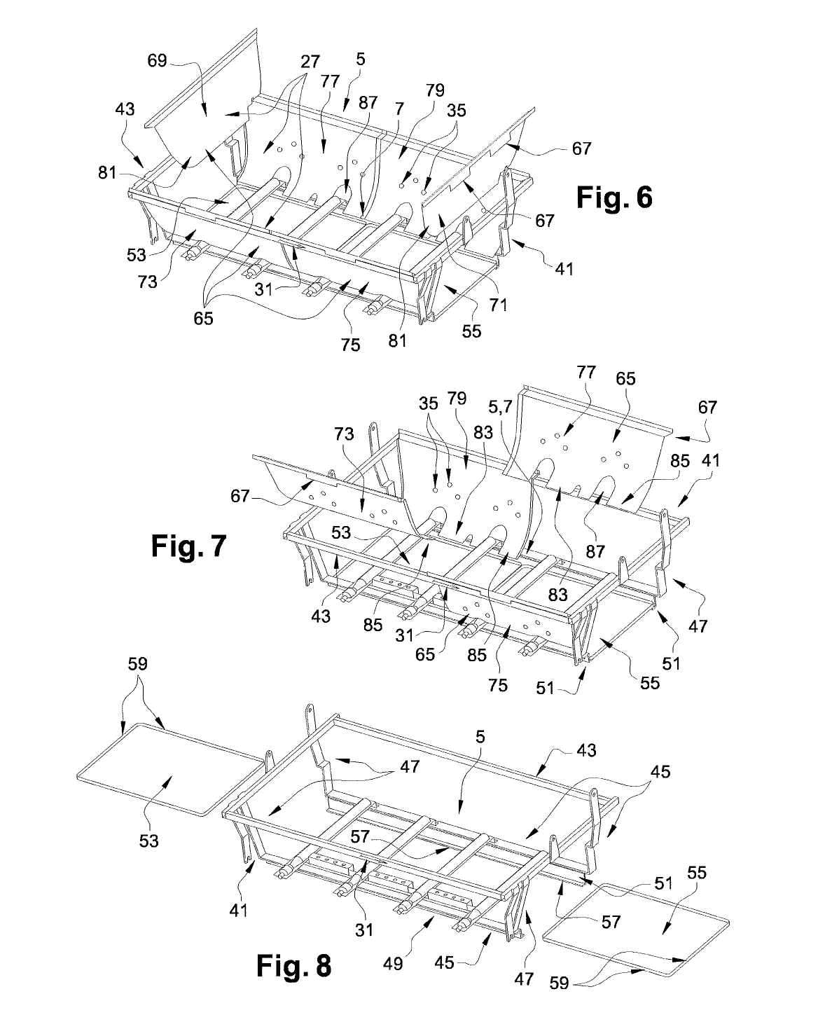

As illustrated on FIG. 3, the cooking well 7 is delimited in the low and lateral part by the cooking enclosure and in the high part by the opening 5. As is also illustrated in the exploded views of the FIGS. 6 to 8, the cooking enclosure 7 comprises a support 41.

The support 41 comprises a frame 43 surrounding the opening 5 of the cooking well 7 and two profiles 45 extending from the frame 43 along the main direction 31 of the opening 5 with respect to the horizontal, around the lateral and lower part of the cooking well 7.

The profiles 45 have substantially vertical parts 47 along the lateral part of the cooking well 7 and two horizontal parts 49 along the lower part of the cooking well 7.

The two horizontal parts 49 of the profiles 45 each comprise a guiding 51 for a tank comprising a first 53 and a second 55 tray. Each guiding 51 comprises a horizontal supporting surface 57 of the trays 53, 55. The guidings 51 are arranged so that the trays 53, 55 slide along the main direction 31 of the opening 5 with respect to the

The trays 53, 55 are of rectangular shape and have a rim 59 oriented towards the opening 5 of the cooking well 7. The trays 53, 55 may slide along the guidings 51 and be detached from the support 41 as illustrated on FIG. 8.

A first lateral opening 61 of the cooking apparatus 1 located under the lateral right working plane 25 and a second lateral opening 63 of the cooking apparatus 1 located under the lateral left working plane 23 allow a user of the cooking apparatus 1 to remove the trays 53, 55 manually.

As illustrated on FIGS. 3, 6 and 7, the trays 53, may be slid along the guidings 51 to an inserted position. In inserted position, the trays 53, 55 are centered horizontally with respect to the opening 5 of the cooking well 7. In inserted position, the trays 53, 55 constitute a lower inner portion of the cooking enclosure 27.

As illustrated on FIG. 3, the lateral inner part of the cooking enclosure 27 is constituted of removable panels 65. The removable panels 65 comprise securing means removable from the frame. As illustrated on FIG. 3, the securing means comprise hooks 67.

The left 69 and right 71 panels are in contact with the substantially vertical parts 47 of the profiles 45 of the support 41. The front 73, 75 and rear 77, 79 panels, are in contact with the horizontal parts 49 of the profiles 45.

FIG. 3 has the panels 65 in inserted position. In inserted position the panels 65 are stationary. However, the panels 65 may be removed from the support 41. In order to do this, the panels 65 must be pivoted around the frame 43 in such a manner as to bring the low parts of the panels 65 towards the top. Then, the hooks 67 must be removed from the frame 43 by a horizontal translation in the direction of the outside of the cooking well 7.

The left 69 and right 71 panels or lateral panels 69, 71 have an extension direction transversal to the main extension direction 31 of the opening 5. The left 69 and right 71 panels are substantially vertical and have a slight slope in the direction of the inside of the cooking well 7.

According to the horizontal, the left 69 and right 71 panels have a first advance 81 towards the inside of the cooking well 7 with respect to the adjoining rim 59 of the adjoining tray 53, 55 and with respect to the substantially vertical parts 47 adjoining the support.

Each front 73, 75 and rear 77, 79 panel has a slope in the direction of the inside of the cooking well 7. Along the horizontal, the base of the slope 83 of each front 73, 75 and rear 77, 79 panel has a second advance 85 towards the inside of the cooking well 7 with respect to the adjoining rim 59 of the adjoining the tray 53, 55 and with respect to the adjoining horizontal parts 49 of the support 41.

Each front 73, 75 and rear 77, 79 panel also has two notches 87 for the passage of the burners 29. The notches 87 are arranged at the bases of the slopes 83 of the front 73, 75 and rear 77, 79 panels and extend upwards. It is to be noted that the notches 87 are aligned vertically with the transversal walls 33.

Each panel 65 has with the adjacent panel 65 an overlapping area 89, 91 with respect to the inside of the cooking well 7. Each panel 65 comprises an edge which is superimposed to an adjacent panel 65 edge in the overlapping area. Each overlapping area 89, 91 extends along a sloping line common to said panel 65 and to said adjacent panel 65.

Each front 73, 75 or rear 77, 79 panel has with the adjacent front 73, 75 or rear 77, 79 panel a first overlapping area 89.

As illustrated on FIG. 4, the rear left panel 77 and the rear right panel 79 have a first overlapping area 89.

The rear left panel 77 has a border 93 in the first overlapping area 89, the border 93 comprising a profile 95 along the common sloping line 97 with the rear right panel 79, the profile 95 having a convex shape with respect to the inside of the cooking well and a concave shape with respect to the outside of the cooking well 7.

As illustrated on FIG. 3 and according to the presented embodiment, the common sloping line 97 is continuous and is comprised in a plane transversal to the rear left panel 77 and to the rear right panel 79, said transversal plane being vertical.

According to a non-represented variant, this transversal plane may be oblique with respect to the vertical.

According to another non represented variant, the common sloping line 97 can extend outside the transversal plane, for example by having a curved profile or a profile comprising several segments.

As illustrated on FIG. 4 and according to the presented embodiment, the border 93 of the rear left panel 77 is located behind the rear right panel 79 with respect to the inside of the cooking well 7.

The rear right panel 79 has a shape that is complementary to the rear left panel 77 in the first overlapping area 91. Thus, the rear right panel 79 also has a border 99 comprising a profile 101 along the common sloping line 97 with the rear left panel 77. The profile 101 of the rear right panel 79 also has a convex shape with respect to the inside of the cooking well 7 and a concave shape with respect to the outside of the cooking well 7.

The first overlapping area 89 of the front left 73 and front right 75 panels is not described as it is similar to the arrangement of the rear left 77 and rear right 79 panels.

Each front 73, 75 or rear 77, 79 panel has with the adjacent lateral panel 69, 71 a second overlapping area 91.

As illustrated on FIG. 5, the rear left panel 77 has a transversal flap 103 with respect to the main direction 31 of the opening 5 of the cooking well 7. The transversal flap 103 is located in the rear part of the left panel 69 with respect to the inside of the cooking well 7. This overlap of the transversal flap 103 and the left panel 69 with respect to the inside of the well constitutes the second overlapping area 91.

The second overlapping areas 91 of the lateral panels 69, 71 with the front panels 73, 75 and the rear right panel 79 are not described as they are identical.

Thus, the panels 65 constitute an inner portion achieving a horizontal contour of the cooking well 7.

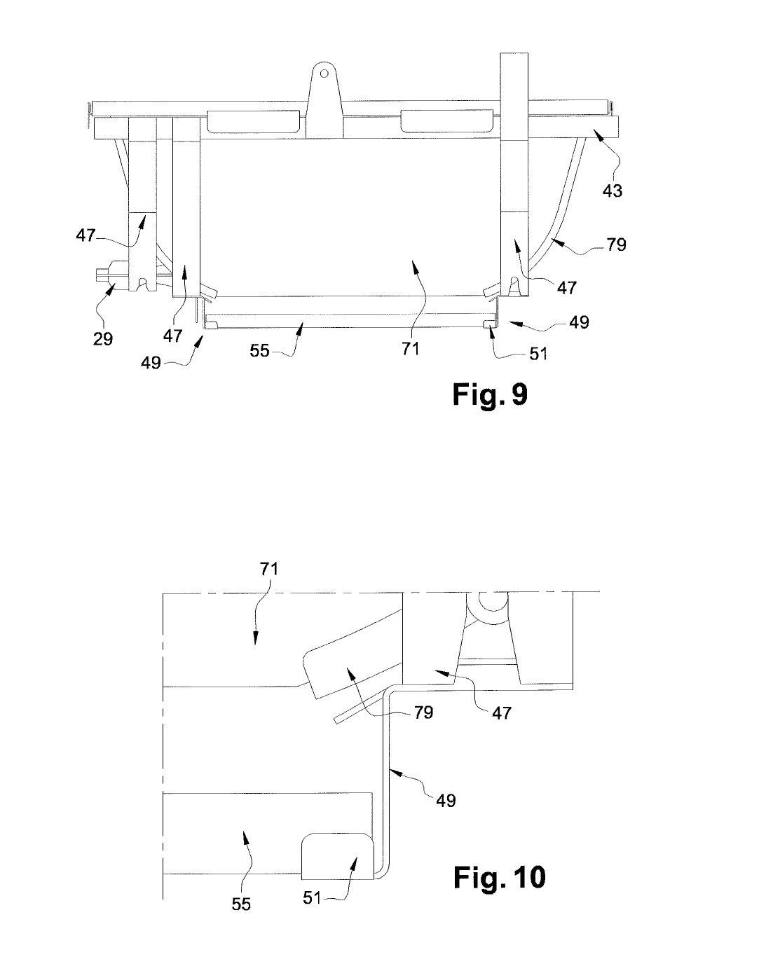

As illustrated on FIGS. 9 and 10, the trays 53, 55 are distant from the panels 65 in order to allow the trays 53, 55 to slide along the guidings 51.

Hereinabove, the cooking apparatus 1 has been described. Here below, the operating thereof is explained in a using example for the cooking of a foodstuff on the cooking plate 3 or on the cooking grill 9.

Turning on the burners 29 generates heat released by combustion. The heat diffuses towards the top of the cooking well 7 by convection. The transversal walls 33 located above the burners distribute the heat currents so that the whole surface of the cooking grill 9 and the cooking plate 3 are uniformly heated.

A food, such as for example a piece of meat is disposed on the cooking grill 9 or the cooking plate 3. As a reaction to the heating caused by combustion, liquid residue is discharged by the meat.

The liquid residue drips onto the cooking grill 9 and the cooking plate 3 in order to penetrate in the cooking well 7 through the openings 15 of the cooking plate 3 and the cooking grill 9.

In a first case, the liquid residue may fall onto one of the panels 65. In this case the slope of the panels 65 guides the liquid residue towards one of the trays 53, 55. The first 81 or second 85 advances of the panels 65 hence prevent the liquid residue from entering into the outside of the cooking well. The liquid residue arrives onto one of the trays 53, 55. The rims 59 of the tray 53, 55 allow the liquid residue to remain on the trays 53, 55.

In a second case, the liquid residue may drop onto the transversal walls 33. In this case the liquid residue is guided by the slopes 34 of the transversal walls 33 and falls onto one of the trays 53, 55. The transversal walls 33 protect on the one hand the burners 29 and on the other hand the notches 87 from the dropping of the liquid residue.

In a last case in point, the liquid residue drops directly into one of the trays 53, 55 from an opening 15 of the cooking grill 9 or the cooking plate 3. In this case the panels 65 protect against the splashing of liquid residue. Thus, the liquid residue does not seep into the outside of the cooking well 7 in the cooking apparatus 1.

Following the cooking of the foodstuff, the trays 53, 55 may be taken out of the cooking apparatus 1 in order to empty the liquid residue and to be cleaned. Likewise, the panels 65 may be removed from the cooking enclosure 27 for cleaning without having to dismantle other parts of the cooking apparatus 1.

According to the presented embodiment, the panels 65 and the trays 53, 55 are dimensioned to be able to be washed in a dishwasher.

As it is known per se, the invention is not limited to the sole embodiment of this cooking apparatus described hereinabove by way of example, but it encompasses on the other hand all variants.

1 A cooking apparatus comprising:
a cooking well defining a cooking enclosure having an upper opening,
a grill and/or cooking plate positioned facing the opening,
at least a burner having at least a heating part disposed in the cooking enclosure,
the cooking enclosure comprising an inner lateral wall including at least two removable panels intended to be secured to a support comprised within the apparatus,
in which a first removable panel and a second adjacent removable panel have an overlapping area, the overlapping area extending along a sloping line common to the first and second removable panels.

2. The cooking apparatus according to claim 1, wherein the first removable panel comprises an edge superimposed to an edge of the second panel in the overlapping area.

3. The cooking apparatus according to claim 1, wherein each panel extends facing the cooking enclosure and has a slope oriented towards the inside of the cooking well.

4. The cooking apparatus according to claim 1, wherein the first removable panel is form-fitted with the second removable panel on the first overlapping area.

5. The cooking apparatus according to claim 4, wherein the first panel has a border in the overlapping area, the border being a profile along the common sloping line, the profile having a convex shape with respect to the inside of the cooking well and a concave shape with respect to the outside of the cooking well.

6. The cooking apparatus according to claim 1, wherein, the cooking enclosure comprises a third removable panel transversal to the first removable panel, the first and third panels having an overlapping area extending transversally to the slope of the first panel facing a flap arranged on the first or on the third panel.

7. The cooking apparatus according to claim 1, wherein at least one panel has a notch arranging a space of the enclosure for placing a burner.

8. The cooking apparatus according to claim 1, wherein an inner portion achieving a horizontal contour of the cooking well is constituted by a plurality of panels, each panel having with the adjacent panel an overlapping area.

9. The cooking apparatus according to claim 1, wherein the support of the cooking apparatus comprises a frame surrounding the upper opening, the removable panels comprising means for removeably securing to the frame.

10. The cooking apparatus according to claim 9, wherein the support comprises a set of profiles extending from the frame around the cooking well, openings of the support being arranged between the profiles.

11. The cooking apparatus according to claim 1, wherein the cooking enclosure comprises at least a removable tank constituting an area for collecting residue from the cooking.

12. The cooking apparatus according to claim 11, wherein the tank extends along at least a horizontal direction towards the outside of the well beyond the base of the slope of the adjoining panel.

13. The cooking apparatus according to claim 11, wherein the tank is arranged at a distance from the panels.
